(19) United States
(12) Patent Application Publication
(10) Pub. No.: US 2017/0334196 A1
(43) Pub. Date: Nov. 23, 2017

(54) METHOD AND CONTROLLER FOR IMPROVING PRINT QUALITY OF AN INKJET PRINTING SYSTEM

(71) Applicant: Océ Holding B.V., Venlo (NL)

(72) Inventor: Benno Petschik, Markt Schwaben (DE)

(73) Assignee: Océ Holding B.V., Venlo (NL)

(21) Appl. No.: 15/596,614

(22) Filed: May 16, 2017

(30) Foreign Application Priority Data
May 17, 2016 (DE) 10 2016 109025.5

(51) Int. Cl. B41J 2/045

(52) U.S. Cl. CPC B41J 2/04508; B41J 2/04586

(57) ABSTRACT

In a method to create a print image with an inkjet printing system that has optional nozzles, for each image point, a distribution parameter can be determined. The distribution parameter can indicate how the ink quantity that is to be ejected for the image point is to be divided up among the optional nozzles. A controller can be configured to control a printing system to perform the method.

### CROSS REFERENCE TO RELATED APPLICATIONS

This patent application claims priority to German Patent Application No. 10 2016 109025.5, filed May 17, 2016, which is incorporated herein by reference in its entirety.

### BACKGROUND

The present disclosure is directed to a method and a corresponding controller for improvements of the print quality of an inkjet printing system.

High-production inkjet printing systems typically operate according to the one-pass printing principle. A print head and the recording medium to be printed to are thereby moved relative to one another, and the print image is applied onto the recording medium in a single pass. The nozzles of a print head are most often arranged so that a specific geometric clearance of the nozzles is realized transversal to a transport direction in order to realize a specific image point (pixel) resolution transversal to the transport direction (i.e. within a line of the print image). On the other hand, in the transport direction within a nozzle track (i.e. within a column of the print image), typically precisely one nozzle is used in order to print image points.

The one-pass printing principle allows a high print speed. However, it is disadvantageous that failing nozzles or ink droplets that are ejected at an angle directly lead to a visible streakiness (in the transport direction) in the print image.

U.S. Pat. No. 7,399,059B2 describes a printing system having multiple redundant print heads that may be used to print different lines of a print image in alternation. The failure of one nozzle of a print head may thus be at least partially compensated by the redundant print head.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 illustrates an example of an inkjet printing system according to an exemplary embodiment of the present disclosure;

FIG. 2a illustrates a distribution matrix for distribution of the ink quantity of image points to be printed to optional nozzles according to an exemplary embodiment of the present disclosure;

FIG. 2b illustrates a distribution matrix composed of partial distribution matrices according to an exemplary embodiment of the present disclosure; and

FIG. 3 a workflow diagram of a method for printing to a recording medium according to an exemplary embodiment of the present disclosure.

The exemplary embodiments of the present disclosure will be described with reference to the accompanying drawings.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure.

The present document deals with the technical object of further reducing the effects of defective or impaired nozzles on the print quality of an inkjet printing system.

According to one aspect, a method for printing to a recording medium by means of an inkjet printing system is described, which inkjet printing system comprises a plurality of first nozzles and a plurality of second nozzles for printing a corresponding plurality of image points of a line of a print image. The plurality of first nozzles and plurality of second nozzles are configured to eject ink of the same color.

The method includes the determination of a plurality of distribution parameters for the corresponding plurality of image points, wherein one distribution parameter of the plurality of distribution parameters for a corresponding image point of the plurality of image points indicates a distribution of a quantity of ink to be ejected for the corresponding image point at a corresponding first nozzle of the plurality of first nozzles and at a corresponding second nozzle of the plurality of second nozzles. The plurality of distribution parameters is determined such that the plurality of distribution parameters for at least two image points of the plurality of image points of the line of the print image indicates a different distribution of the ink quantity to be ejected. The method additionally includes the activation of the plurality of first nozzles and the plurality of second nozzles to print the plurality of image points of the line of the print image, depending on the plurality of distribution parameters.

According to a further aspect, a controller for controlling an inkjet printing system is described. The inkjet printing system comprises a plurality of first nozzles and a plurality of second nozzles to print a corresponding plurality of image points of a line of a print image. The plurality of first nozzles and the plurality of second nozzles are thereby configured to eject ink of the same color.

In an exemplary embodiment, the controller is configured to determine a plurality of distribution parameters for the corresponding plurality of image points. One distribution parameter of the plurality of distribution parameters for a corresponding image point of the plurality of image points indicates a distribution of a quantity of ink to be ejected for the corresponding image point at a corresponding first nozzle of the plurality of first nozzles and at a corresponding second nozzle of the plurality of second nozzles. In an exemplary embodiment, the plurality of distribution parameters is determined such that the plurality of distribution parameters for at least two image points of the plurality of image points of the line of the print image indicates a different distribution of the ink quantity to be ejected. The controller is additionally configured to activate the plurality of first nozzles and the plurality of second nozzles to print the plurality of image points of the line of the print image, depending on the plurality of distribution parameters.

According to a further aspect, an inkjet printing system is described that comprises the controller according to exemplary embodiments of the present disclosure.

FIG. 1 shows a block diagram of an inkjet printing system 100 according to an exemplary embodiment of the present disclosure. In an exemplary embodiment, the inkjet printing system 100 is a digital printing system. In an exemplary embodiment, the printing system 100 depicted in FIG. 1 is designed for printing to a web-shaped recording medium 120 (also designated as a “continuous feed”). However, the aspects described in this document are also applicable to printing systems 100 that are configured to print to a sheet-shaped or page-shaped recording medium 120. A web-shaped recording medium 120 is typically unspooled from a roll (the take-off) and then supplied to the print group of the printing system 100. Via the print group, a print image is applied onto the recording medium 120, and after fixing / drying of the print image the printed recording medium 120 may be taken up again on an additional roll (the take-up) or be cut into sheets. In FIG. 1, the transport direction of the recording medium 120 is represented by an arrow (i.e., the right direction relative to the drawing). The printing system 100 thereby typically has only a single transport direction, such that each point of the recording medium 120 is directed only once past a defined nozzle of the printing system 100. The nozzles may thereby be installed fixed (i.e. immovably) in the printing system 100. The recording medium 120 may be produced from paper, paperboard, cardboard, metal, plastic, textiles and/or other suitable and printable materials.

In an exemplary embodiment, the printing system 100 comprises four print head arrangements 112, 122 (that are respectively also designated as print bars). Different print bars 112, 122 may be used for printing with inks of different colors (for example black, cyan, magenta and/or yellow). The printing system 100 may comprise still more print bars 112, 122 for printing with additional colors or additional inks (for example MICR ink).

In an exemplary embodiment, a print bar 112, 122 comprises one or more print heads 113, 123. In the depicted example, a print bar 112, 122 respectively comprises five print heads 113, 123. The orientation position/orientation of a print head 113, 123 within a print bar 112, 122 may depend on the type of print head 113, 123. Each print head 113, 123 comprises multiple nozzles or nozzle arrangements, wherein each nozzle is configured to fire or eject ink droplets onto the recording medium 120. A print head 113, 123 may, for example, comprise 2558 effectively used nozzles that are arranged along one or more rows transversal to the transport direction of the recording medium 120. The nozzles in the individual rows may be arranged offset from one another. A respective row (line) on the recording medium 120 may be printed on the recording medium 120 transversal to the transport direction by means of the nozzles of a print head 113, 123. An increased resolution may be provided via the use of a plurality of rows with (transversally offset) nozzles. In total, via a print bar 112, 122 depicted in FIG. 1, for example, K=12790 droplets may be fired along a transversal line (i.e. along a row) onto the recording medium 120 (for example, for a print width of approximately 21.25 inches with 600 dpi (dots per inch)). In other words, a print bar 112, 122 may comprise K (for example K =12790) nozzles for printing a row (or transversal line) of a print image. Each print bar 112, 122 may thus be configured to print a transversal line of a specific color onto the recording medium 120.

In an exemplary embodiment, the printing system 100 additionally comprises a controller 101. In an exemplary embodiment, the controller 101 includes activation hardware. In an exemplary embodiment, the controller 101 is configured to activate the actuators of the individual nozzles of the individual print heads 113, 123 to apply a print image onto the recording medium 120 based on print data. The print data are thereby typically present in rastered form and indicate, for each image point (i.e. pixel) of the print image, whether and possibly with what droplet size an ink ejection should take place. In an exemplary embodiment, the controller 101 includes processor circuitry that is configured to perform one or more functions and/or operations of the controller 101, including activating the actuators of the individual nozzles of the individual print heads 113, 123 to apply a print image onto the recording medium 120 based on print data.

In an exemplary embodiment, the printing system 100 thus comprises K nozzles that may be activated with a specific activation frequency or with a specific line clock in order to print a line (transversal to the transport direction of the recording medium 120) with K image points or K columns on the recording medium 120. The activation frequency or the line clock thereby depend on the print speed (number of printed lines per time unit) of the printing system 100. The nozzles are typically immovable or installed in a fixed manner in the printing system 100, and the recording medium 120 is directed past the stationary nozzle arrangements with a defined transport velocity. A specific nozzle thus prints image points of a corresponding specific column (in the transport direction) onto the recording medium 120. A maximum of one ink ejection thus takes place via a defined nozzle per line of a print image.

In an exemplary embodiment, the printing system 100 depicted in FIG. 1 comprises (at least) two redundant or optional print bars 112, 122 for at least one print color (possibly for each print color). The printing system consequently comprises (at least) two redundant print heads 113, 123 for a print color. An image point of a print image may thus theoretically be printed by two nozzles. Via the provision of optional nozzles for the printing of an image point of a print image, the print quality of the print image may be improved on average even given the presence of an impaired nozzle. In particular, an image point may possibly be printed entirely by the nozzle of a first print head 113 or entirely by the corresponding nozzle of a second print head 123.

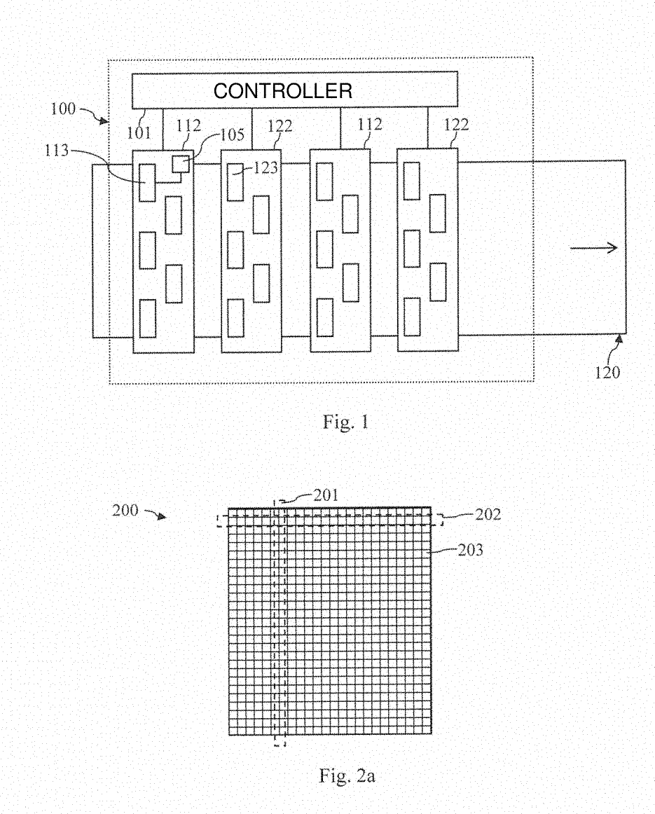

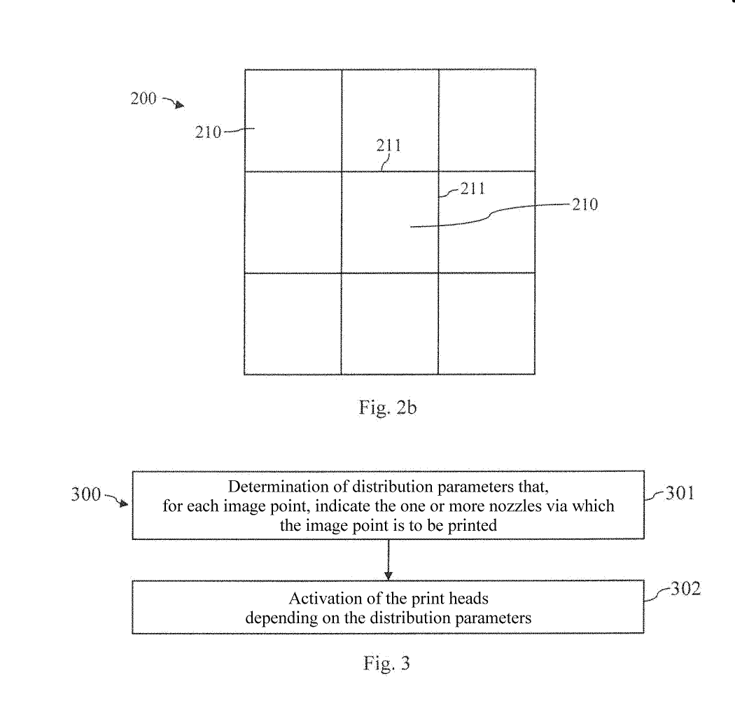

FIG. 2a shows a distribution matrix 200 having a plurality of distribution parameters 203 for a corresponding plurality of image points of a print image according to an exemplary embodiment of the present disclosure. In an exemplary embodiment, the distribution matrix 200 comprises a plurality of lines 202 for a corresponding plurality of lines of a print image, and a plurality of columns 201 for a corresponding plurality of columns of a print image. A distribution parameter 203 of the distribution matrix 200 indicates how a corresponding image point of a print image is to be printed by the at least two nozzles of the at least two redundant print heads 113, 123. In particular, a distribution parameter 203 may indicate a first droplet size of a first ink droplet that is to be ejected by a first nozzle and a second droplet size of a second ink droplet that is to be ejected by a second nozzle. The corresponding image point of a print image is then formed by the combination of the first ink droplet and the second ink droplet. The effects of impaired nozzles may thus be reduced via the use of redundant nozzles or print heads 113, 123.

In one example, the distribution parameter 203 may indicate in binary form (for example by the value 0 or 1) whether an image point should be printed either entirely by the first nozzle or entirely by the second nozzle. The distribution matrix 200 may thus indicate, in the manner of a checkerboard pattern, which nozzle of a nozzle pair, or which print head 112, 123, prints the image points of a column 201 of a print image. The checkerboard pattern may thereby change stochastically with time so that, over a longer period of time, a uniform utilization of the nozzles exists, and such that effects of impaired nozzles on the quality of the print image are reduced.

In a further example, the distribution parameter 203 may indicate in a quasi-continuous manner (for example via values between 0 and 1) what portion of the total ink quantity for an image point should be provided by the first nozzle and what portion of the total ink quantity for an image point should be provided by the second nozzle. The portions of the total ink quantity may thereby change stochastically with time, such that effects of impaired nozzles on the quality of the print image are reduced.

The distribution parameters 203 for a nozzle pair (i.e. the values of a distribution parameter 203 along a column 201 of a print image) thus changes with time (for example stochastically). In other words, the pattern with which image points of a column 201 of a print image are printed by a nozzle pair changes with time. Effects of an impaired nozzle of the nozzle pair on the quality of the print image may thus be especially efficiently reduced.

FIG. 3 shows a workflow diagram of a method 300 for printing to a recording medium 120 using an inkjet printing system 100 according to an exemplary embodiment of the present disclosure. As depicted in FIG. 1, the printing system 100 comprises a plurality of first nozzles and a plurality of second nozzles for printing a corresponding plurality of image points of a line 202 of a print image. The plurality of first nozzles may be arranged in a first print head 113 and/or in a first print bar 112, and the plurality of second nozzles may be arranged in a second print head 113 and/or in a second print bar 122. The plurality of first nozzles and the plurality of second nozzles are thereby configured to eject or fire ink of the same color. In other words, the printing system 100 may comprise redundant or optional groups of nozzles for printing image points of the print image. Both the plurality of first nozzles and the plurality of second nozzles may thereby be configured to print (possibly alone) the plurality of image points of the line 202 of the print image.

The printing system 100 may thus have a first print head 113 with a plurality of first nozzles and a second print head 123 with a plurality of second nozzles. The second print head 123 is thereby arranged parallel to the first print head 113 so that nozzle pairs are respectively formed from a first nozzle from the first print head 113 and a second nozzle 123 from the second print head 123. The nozzles of a nozzle pair may thereby print to the same position on a recording medium 120. In other words, the nozzles of a nozzle pair may print image points to coinciding positions on a recording medium 120.

For this purpose, the print heads 113, 123 are synchronized with one another in order to compensate for the spatial offset between the two print heads 113, 123 (or between the two print bars 112, 122). The clearance between the first print head 113 and the second print head 123 may be A in the transport direction of the recording medium 120. Furthermore, the transport velocity of the recording medium 120 may be G. The activation points in time or the line clocks of the print heads 113, 123 may then be synchronized on the basis of A and G, in particular on the basis of A/G. The second nozzle of a nozzle pair may in particular fire A/G seconds after the first nozzle in order to print an image point at the same position on a recording medium 120.

In an exemplary embodiment, the printing system 100 may be configured to move the recording medium 120 and the plurality of first and second nozzles relative to one another in a transport direction. The recording medium 120 and the plurality of first and second nozzles are thereby typically moved relative to one another exclusively in the transport direction in order to print the print image in a single pass (without needing to reverse the relative transport direction between the recording medium 120 and the plurality of first and second nozzles). Image points that are arranged in a straight line transversal to the transport direction are designated in this document as the image points of a line 202 of the print image. On the other hand, image points that are arranged in a straight line in the transport direction are designated in this document as the image points of a column 201 of the print image.

In an exemplary embodiment, the plurality of first nozzles and the plurality of second nozzles may form a corresponding plurality of nozzle pairs, wherein each nozzle pair comprises a first nozzle and a second nozzle. In an exemplary embodiment, precisely one column 201 of a print image may thereby be printed by a nozzle pair. The image points of a column 201 of the print image may thereby respectively be printed
by the first nozzle of the nozzle pair alone,
by the second nozzle of the nozzle pair alone, or via a superposition of ink droplets from the first nozzle and from the second nozzle of the nozzle pair.

In an exemplary embodiment, the method 300 comprises the determination 301 of a plurality of distribution parameters 203 for the corresponding plurality of image points of the line 202 of the print image. A distribution parameter 203 may be determined for each image point (of the line 202) of the print image. For a corresponding image point, the distribution parameter 203 thereby shows a distribution of the quantity of ink to be ejected for the corresponding image point at a corresponding first nozzle of the plurality of first nozzles and at a corresponding second nozzle of the plurality of second nozzles.

In an exemplary embodiment, a specific nozzle pair may be responsible for the printing of a specific image point. Typically, each column 201 of the print image is thereby printed by precisely one nozzle pair (in a one-to-one relationship). The distribution parameter 203 for the specific image point may indicate a first partial ink quantity that is to be ejected by the first nozzle of the nozzle pair for the printing of the specific image point. Furthermore, the distribution parameter 203 for the specific image point may indicate a second partial ink quantity that is to be ejected by the second nozzle of the nozzle pair for the printing of the specific image point. The specific image point then results via the superposition of the first partial ink quantity and the second partial quantity on the recording medium 120. A distribution parameter 203 may be determined accordingly for each image point of a print image.

In an exemplary embodiment, the plurality of distribution parameters 203 is thereby determined such that the plurality of distribution parameters 203 indicates a different distribution of the partial ink quantities to be ejected for at least two image points of the plurality of image points of the line 202 of the print image. In other words, the distribution of the “print load” on the nozzles of the nozzle pairs may vary within at least one line 202 and/or within at least one column 201 of the print image (for example in a stochastic or random manner).

In an exemplary embodiment, the method 300 additionally comprises the activation 302 of the plurality of first nozzles and the plurality of second nozzles for printing the plurality of image points of the line 202 of the print image, depending on the plurality of distribution parameters 203. As presented above, the distribution parameters 203 thereby show different distributions of the “print load” to the redundant or optional nozzles. Via such a change of the distribution of the “print load”, effects of impairments of individual nozzles may be particularly efficiently masked and therefore be made invisible to an observer. The print quality of the printing system 100 may be increased as a consequence of this. The increase in the print quality may thereby in particular be achieved without the use of explicit means of detection of impaired nozzles (for example of camera systems with image analysis algorithms), and thus cost-effectively.

In an exemplary embodiment, within the scope of the method 300, a distribution matrix 200 having a plurality of lines 202 may be determined for a corresponding plurality of lines 202 of the print image. Each line 202 of the distribution matrix 200 thereby includes a plurality of distribution parameters 203 for a plurality of image points of a line 202 of a print image. In other words, a distribution parameter 203 may be determined for each of the image points, wherein the distribution parameter 203 may be arranged in a distribution matrix 200 that has the same dimension as the raster matrix of a (rastered) print image with a raster of image points. The individual distribution parameters may thus be efficiently associated with the individual image points of a print image.

In an exemplary embodiment, the plurality of first nozzles and the plurality of second nozzles may then be activated to print the plurality of lines 202 of the print image depending on the distribution matrix 200. The distribution matrix 200 for each nozzle pair thereby comprises a column 201 having distribution parameters 203 for a corresponding column 201 of the print image. The distribution parameters 203 of a column 201 may thereby indicate statistical or randomly changing distributions between the two nozzles of a nozzle pair in order to mask the impairments of a nozzle in an optimally comprehensive manner.

The distribution parameter 203 for an image point thus indicates which of the two nozzles of a nozzle pair should print the image point, or how the required total ink quantity for an image point is to be distributed at the two nozzles of a nozzle pair. The distribution parameter 203 may thereby be adapted dynamically. In particular, the distribution parameter 203 may change with each print line.

As presented above, the plurality of distribution parameters 203 may be determined such that the ink quantity to be ejected is distributed stochastically and/or randomly between the plurality of first nozzles and the plurality of second nozzles. In particular, the first portion of a total ink quantity that is assigned to a first nozzle of a nozzle pair and the second portion of a total ink quantity that is assigned to a second nozzle of a nozzle pair may thereby be varied (stochastically or randomly). A particularly good masking of nozzle impairments may be achieved via a (quasi-)random change of the distribution.

In an exemplary embodiment, the distribution parameters 203 are independent of the print image to be printed. In particular, the distribution parameters 203 may be independent of print data of the print image to be printed. For example, the distribution parameters 203 may be predetermined and possibly stored at the printing system 100. In particular, a fixed distribution matrix 200 may be provided that is repeatedly used for successive (typically different) print images. A resource-efficient increase in the print quality may thus be produced. The determination of the distribution parameters 203 or of the distribution matrix 200 may thus include access to a storage unit (for example to a storage unit of the printing system 100) (or correspond to access to a storage unit) in order to read the distribution parameters 203 or the distribution matrix 200 from said storage unit.

In an exemplary embodiment, the plurality of distribution parameters 203, and in particular the distribution matrix 200, may be determined using a rastering method to create an amplitude-modulated and/or frequency-modulated raster grid for a line 202 or area inked with a mean color value or greyscale value. In other words, to determine a distribution matrix 200, methods may be resorted to that are used to reproduce (uniformly inked) areas with a specific mean color value or greyscale value (i.e. for what are known as “halftones”). In particular, the raster grid for determining the plurality of distribution parameters 203 or for determining the distribution matrix 200 may include a halftone screening mask, for example a blue noise mask. Nozzle impairments may be compensated especially comprehensively via the use of such screening masks.

In an exemplary embodiment, the mean color value or greyscale value may thereby be between a first color value or greyscale value and a second color value or greyscale value. For example, the mean color value or greyscale value may correspond to the mean value of the first color value or greyscale value and second color value or greyscale value. For example, the first color value or greyscale value may correspond to an inking of 0%, the second color value or greyscale value may correspond to an inking of 100%, and the mean color value or greyscale value may correspond to an inking of 50%.

In an exemplary embodiment, the plurality of first nozzles may be associated with the first color value or greyscale value, and the plurality of second nozzles may be associated with the second color value or greyscale value. In particular, given use of a rastering method, a distribution parameter 203 for a specific image point may assume either the first color value or greyscale value or the second color value or greyscale value. The distribution parameter 203 may indicate that the specific image point should be printed by a first nozzle of a nozzle pair if the distribution parameter 203 assumes the first color value or greyscale value. Otherwise, the distribution parameter 203 may indicate that the image point should be printed by a second nozzle of the nozzle pair if the distribution parameter 203 assumes the second color value or greyscale value.

The raster grid may include multiple partial grids that are arranged next to one another in order to cover the line 202 of the print image. In particular, a specific area of the print image may be covered by the partial grids. The partial grids may thereby be designed such that a transition between two adjacent partial grids proceeds continuously. Accordingly, the distribution matrix 200 may be composed of multiple partial distribution matrices 210 (as depicted in FIG. 2b). Each partial distribution matrix 210 may correspond to a partial grid. The partial distribution matrices 210 may thus form constant and/or continuous transitions with adjacent partial distribution matrices 210 at the edges 211. Distribution matrices 200 for relatively large print images may thus be created from a relatively small partial distribution matrix 210. Due to the constancy and/or continuity at the edges 211, no visible artifacts are thereby generated by the merging of the partial distribution matrices 210.

In an exemplary embodiment, the plurality of distribution parameters 203 may additionally be determined such that the plurality of image points of a line 202 of the print image should be printed by at least one first nozzle of the plurality of first nozzles and by at least one second nozzle of the plurality of second nozzles. Within a line 202 of the print image, both at least one first nozzle from the plurality of first nozzles and at least one second nozzle from the plurality of second nozzles are thus typically used. An even and artifact-reduced distribution of the “print load” at the two nozzles of a nozzle pair may thus be produced.

The distribution parameters 203 may be such that an image point of the plurality of image points is printed either by a first nozzle or by a second nozzle of a nozzle pair. Possible artifacts that may occur given the superposition of partial ink quantities of the nozzles of a nozzle pair may thus be avoided.

In an exemplary embodiment, the first nozzles may be configured to eject respective droplets with M₁ different droplet sizes or ink quantities Tₘ₁, with m1=1, . . . , M₁ (for example M₁=3, 4, 5 or more). Accordingly, for example, the second nozzles may be configured to eject respective droplets with M₂ different droplet sizes or ink quantities Tₘ₂, with m2=1, . . . , M₂ (for example M₂=3, 4, 5 or more). Examples of ink quantities are: 5 pl, 7 pl, 9 pl, 12 pl, etc. The different ink quantities may also include the quantity 0 pl (meaning no ejection of ink). For each image point, the print data for a print image may indicate
whether a droplet should be ejected (i.e. whether a “white” image point or a “non-white” image point should be printed); and
if a droplet should be ejected, what total ink quantity should be ejected. M_{G} different total droplet sizes or total ink quantity T_{mG}, with mG=1, . . . , M_{G}, may thereby be indicated in the print data (for example M_{g}=3, 4, 5).

In an exemplary embodiment, the distribution parameters 203 for an image point that is to be printed with the total ink quantity T_{mG} may indicate what first partial ink quantity Tₘ₁ is to be ejected from the first nozzle and what second partial ink quantity Tₘ₂ is to be ejected from the second nozzle. In an exemplary embodiment, the partial ink quantities Tₘ₁, Tₘ₂ are thereby determined such that Tₘ₁+Tₘ₂=T_{mG}.

In an exemplary embodiment, the distribution parameter 203 may in particular indicate a proportion v of the total ink quantity that should be produced by the first nozzle. The proportion v may thereby assume values between 0 and 1, wherein the value 0 indicates that the first nozzle has no ink to produce, and wherein the value 1 indicates that the first nozzle has to produce the entire ink quantity. The partial ink quantities may thus be determined as Tₘ₁=vT_{mG} and Tₘ₂=(1−v)T_{mG}. Distribution parameters 203 may thus be provided that are independent of the print data of the print image to be printed.

In an exemplary embodiment, a print head 113, 123 or the nozzles of a print head 113, 123 are activated with a specific activation frequency (i.e. with a specific line clock) in order to activate the respective nozzles for ejection of an ink droplet according to said activation frequency. The activation frequency (i.e. the line clock for directly successive lines) thereby depends on the actual transport velocity (i.e. on the relative velocity between recording medium 120 and print head 113, 123) and on the desired resolution in the transport direction of the recording medium 120. The activation frequency is typically limited to a maximum frequency, wherein the maximum frequency indicates how often within a time interval (for example within one second) the nozzles of a print head 113, 123 may eject an ink droplet to print an image point, i.e. how many image points at most the nozzles of a print head may print within a time interval.

In an exemplary embodiment, the plurality of first nozzles may have a first maximum frequency, and the plurality of second nozzles may have a second maximum frequency, wherein the first maximum frequency is lower than or equal to the second maximum frequency, for example. The activation frequency of the printing system 100 may then be lower than or equal to the first maximum frequency. It may thus be ensured that the distribution of the “print load” to nozzle pairs that is described in this document may be realized reliably.

In an exemplary embodiment, an additional print bar 122 may thus be provided (possibly per print color) so that, in each nozzle track, at least two nozzles are available for printing to the image points within the nozzle track (i.e. within the column 201). The print image is distributed to the two print bars 112, 122 of a print color according to a determined rule that is indicated by the distribution matrix 200. The print image is thus generated by both print bars 112, 122. A nozzle failure or a malfunction of a nozzle in a print bar 112 thus does not immediately lead to a clearly visible streakiness, since a portion of the print information continues to be printed with the second print bar 122.

In a color printing system 100, an additional print bar 122 does not necessarily need to be used for each primary color. In an exemplary embodiment, at least the primary color black is furnished with an additional print bar 122, since the greatest visual contrast in the print image is typically present here and streakiness due to malfunctioning nozzles will typically be most clearly visible.

In exemplary embodiments of the present disclosure, a method 300 is thus described in order to create a print image with an inkjet printing system 100 that has redundant or optional nozzles. For each image point, a distribution parameter 203 is thereby determined that indicates how the ink quantity that is to be ejected for the image point is to be divided up among the redundant or optional nozzles. Via the use of changing distribution parameters 203 within a line 202 and/or within a column 201 of the print image, artifacts due to nozzle impairments may be reliably reduced or avoided. Cost-intensive detectors for malfunctioning nozzles may thereby possibly be foregone. The method 300 may thus be implemented cost-effectively.

In an exemplary embodiment, nevertheless, the printing system 100 may comprise one or more detectors (for example, an image sensor or a camera to detect a printed print image) that is configured to detect an impaired nozzle of a nozzle pair. The distribution parameters 203 for a nozzle pair with an impaired nozzle may then be determined depending on the detected impairment. The print quality may thus be further increased.

### CONCLUSION

The aforementioned description of the specific embodiments will so fully reveal the general nature of the disclosure that others can, by applying knowledge within the skill of the art, readily modify and/or adapt for various applications such specific embodiments, without undue experimentation, and without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

For the purposes of this discussion, “processor circuitry” can include one or more circuits, one or more processors, logic, or a combination thereof. For example, a circuit can include an analog circuit, a digital circuit, state machine logic, other structural electronic hardware, or a combination thereof. A processor can include a microprocessor, a digital signal processor (DSP), or other hardware processor. In one or more exemplary embodiments, the processor can include a memory, and the processor can be “hard-coded” with instructions to perform corresponding function(s) according to embodiments described herein. In these examples, the hard-coded instructions can be stored on the memory. Alternatively or additionally, the processor can access an internal and/or external memory to retrieve instructions stored in the internal and/or external memory, which when executed by the processor, perform the corresponding function(s) associated with the processor, and/or one or more functions and/or operations related to the operation of a component having the processor included therein.

In one or more of the exemplary embodiments described herein, the memory can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

### REFERENCE LIST

100 printing system
101 controller of the printing system 100
112, 122 print head arrangement/print bar
113, 123 print head
105 controller of a print bar
120 recording medium
200 distribution matrix
201 column
202 line
203 distribution parameter
210 partial distribution matrix
211 edge
300 method to print to a recording medium
301, 302 method steps

1. A method for printing to a recording medium using an inkjet printing system including a plurality of first nozzles in a first print head and a plurality of second nozzles in a second print head for printing a corresponding plurality of image points of a line of a print image transversal to a transport direction of the printing system, the plurality of first nozzles and the plurality of second nozzles being configured to eject ink of the same color, the method comprising:
determining a plurality of distribution parameters for the corresponding plurality of image points, the plurality of distribution parameters being determined such that, for at least two image points of the plurality of image points of the line of the print image, the plurality of distribution parameters indicates a different distribution of the ink quantity to be ejected, wherein, for a corresponding image point of the plurality of image points, one distribution parameter of the plurality of distribution parameters indicates a distribution of a quantity of ink to be ejected for the corresponding image point at a corresponding first nozzle of the plurality of first nozzles and at a corresponding second nozzle of the plurality of second nozzles; and
activating the plurality of first nozzles and the plurality of second nozzles based on the plurality of distribution parameters to print the plurality of image points of the line of the print image.

2. The method according to claim 1, further comprising:
determining a distribution matrix having a plurality of lines for a corresponding plurality of lines of the print image, each of the plurality of lines of the distribution matrix includes a plurality of distribution parameters; and
activating the plurality of first nozzles and the plurality of second nozzles based on the distribution matrix to print the plurality of lines of the print image.

3. The method according to claim 1, wherein the plurality of distribution parameters are determined such that the ink quantity to be ejected is distributed stochastically between the plurality of first nozzles and the plurality of second nozzles.

4. The method according to claim 1, wherein the plurality of distribution parameters are determined such that the ink quantity to be ejected is distributed randomly between the plurality of first nozzles and the plurality of second nozzles.

5. The method according to claim 1, wherein:
the plurality of distribution parameters are determined using a rastering method to create an amplitude-modulated and/or frequency-modulated raster grid for a line of the print image inked with a mean greyscale value;
the mean greyscale value is between a first greyscale value and a second greyscale value; and
the plurality of first nozzles are associated with the first greyscale value, and the plurality of second nozzles are associated with the second greyscale value.

6. The method according to claim 5, wherein:
a distribution parameter the plurality of distribution parameters for an image point assumes the first greyscale value or the second greyscale value;
the distribution parameter of the plurality of distribution parameters indicates that the image point should be printed by a first nozzle of the plurality of first nozzles if the distribution parameter assumes the first greyscale value; and
the distribution parameter of the plurality of distribution parameters indicates that the image point should be printed by a second nozzle of the plurality of second nozzles if the distribution parameter assumes the second greyscale value.

7. The method according to claim 5, wherein the raster grid configured to determine the plurality of distribution parameters comprises a halftone screening mask.

8. The method according to claim 7, wherein the halftone screening mask is a blue noise mask.

9. The method according to claim 6, wherein the raster grid configured to determine the plurality of distribution parameters comprises a halftone screening mask.

10. The method according to claim 9, wherein the halftone screening mask is a blue noise mask.

11. The method according to claim 5, wherein:
the raster grid comprises multiple partial grids that are arranged next to one another to cover the line of the plurality of lines of the print image; and
the partial grids are designed such that a transition between two adjacent partial grids proceeds constantly or continuously.

12. The method according to claim 1, wherein the plurality of distribution parameters are determined such that the plurality of image points of the line of the print image are to be printed by at least one first nozzle of the plurality of first nozzles and by at least one second nozzle of the plurality of second nozzles.

13. The method according to claim 1, wherein the plurality of distribution parameters are determined such that an image point of the plurality of image points is printed by either a first nozzle or a second nozzle.

14. The method according to claim 1, wherein:
the printing system is configured to move the recording medium and the plurality of first and second nozzles relative to one another in the transport direction; and
the recording medium and the plurality of first nozzles and the plurality of second nozzles are moved relative to one another exclusively in the transport direction to print the print image in a single pass.

15. A non-transitory computer-readable storage medium with an executable program stored thereon, wherein, when executed, the program instructs a processor to perform the method of claim 1.

16. A controller operable to control an inkjet printing system that includes a plurality of first nozzles in a first print head and a plurality of second nozzles in a second print head for printing a corresponding plurality of image points of a line of a print image transversal to a transport direction of the printing system, the plurality of first nozzles and the plurality of second nozzles being configured to eject ink of a same color, the controller being configured to:
determine a plurality of distribution parameters for the corresponding plurality of image points such that, for at least two image points of the plurality of image points of the line of the print image, the plurality of distribution parameters indicates a different distribution of the ink quantity to be ejected, wherein, for a corresponding image point of the plurality of image points, one distribution parameter of the plurality of distribution parameters indicates a distribution of a quantity of ink to be ejected for the corresponding image point at a corresponding first nozzle of the plurality of first nozzles and at a corresponding second nozzle of the plurality of second nozzles; and
activate the plurality of first nozzles and the plurality of second nozzles based on the plurality of distribution parameters to print the plurality of image points of the line of the print image.

17. An inkjet printing system, comprising:
a first print head including a plurality of first nozzles;
a second print head including a plurality of second nozzles, the plurality of first nozzles and the plurality of second nozzles being configured to print a corresponding plurality of image points of a line of a print image transversal to a transport direction of the inkjet printing system, wherein the plurality of first nozzles and the plurality of second nozzles are configured to eject ink of a same color; and
a controller configured to:
determine a plurality of distribution parameters for the corresponding plurality of image points such that, for at least two image points of the plurality of image points of the line of the print image, the plurality of distribution parameters indicates a different distribution of the ink quantity to be ejected, wherein, for a corresponding image point of the plurality of image points, one distribution parameter of the plurality of distribution parameters indicates a distribution of a quantity of ink to be ejected for the corresponding image point at a corresponding first nozzle of the plurality of first nozzles and at a corresponding second nozzle of the plurality of second nozzles; and
activate the plurality of first nozzles and the plurality of second nozzles based on the plurality of distribution parameters to print the plurality of image points of the line of the print image.
